(19) United States
(12) Patent Application Publication
(10) Pub. No.: US 2026/0260865 A1
(43) Pub. Date: Sep. 3, 2026

(54) High Frequency Plasma Light Source

(71) Applicant: neonsee GmbH, Konstanz (DE)

(72) Inventor: Martin Pirmin Maier, Konstanz (DE)

(21) Appl. No.: 19/151,661

(22) PCT Filed: Nov. 18, 2024
(86) PCT No.: PCT/DE2024/100963

§ 371 Date: Jul. 29, 2025

(30) Foreign Application Priority Data
Nov. 27, 2023 (DE) 10 2023 133 105.1

(51) Int. Cl. H01J 61/06; H01J 61/54

(52) U.S. Cl. CPC H01J 61/06; H01J 61/54

(57) ABSTRACT

A high-frequency plasma light source (1) includes an impedance transformer (4) assembly connected to a pressure chamber (5). The impedance transformer (4) includes a coupling pin (8) configured for coupling electromagnetic waves into the high-frequency plasma light source (1) and also includes a coaxial conductor (9) with an inner conductor (9a) and an outer conductor (9b). A dielectric pressure seal (13) and at least one electrically conductive or dielectric connection (10, 12) are present between the inner conductor (9a) and the outer conductor (9b). An inner conductor plasma anchor (6) extends into the pressure chamber (5) and is electrically and mechanically connected to the inner conductor (9a) of the coaxial conductor (9). An outer conductor plasma anchor (7) includes a first end (7a) positioned within the pressure chamber (5) and a second end (7b) mechanically connected to the inner surface of the pressure chamber (5).

### CROSS-REFERENCE TO RELATED APPLICATIONS

The present application is related and has right of priority to German Patent Application No. DE102023133105.1 filed on Nov. 27, 2023 and is a U.S. National Phase of PCT/DE2024/100963 filed on Nov. 18, 2024, both of which are incorporated by reference in its entirety for all purposes.

### TECHNICAL FIELD

The invention relates generally to a high-frequency plasma light source in which, in the operating state, a quasi-capacitively coupled plasma is formed by at least two plasma anchors, and thus the plasma region with the highest energy density is spatially decoupled from the plasma anchors.

### BACKGROUND

US2007194678 AA describes a light source with a coaxial waveguide consisting of an inner and an outer metal conductor separated by quartz glass. The lamp has a discharge tube filled with a noble gas and a luminescent substance. Conductor assemblies made of tungsten and molybdenum extend into the discharge tube. The arrangement enables light emission by a plasma excited through electromagnetic waves in the waveguide. The disadvantages of this arrangement are the lack of impedance matching in the waveguide and the complex construction.

US2012074839 AA discloses a discharge lamp comprising a discharge vessel with a light-emitting substance enclosed therein, as well as antenna members that guide electromagnetic waves into the discharge vessel. An impedance section is also described. This impedance section refers to a part of the discharge lamp specifically designed to contain the electromagnetic waves emanating from the antenna within the lamp and prevent these waves from escaping. The impedance section consists of a loading coil wound around the antenna member that protrudes from the discharge vessel. This coil acts as a type of electromagnetic barrier that keeps the microwave energy within the discharge vessel. A disadvantage of this light source is the complex impedance matching in the launcher required to achieve high luminous efficiency.

### BRIEF SUMMARY

Example aspects of the invention provide a high-frequency plasma light source in which the disadvantages of the state-of-the-art are eliminated.

In the high-frequency plasma light source according to example aspects of the invention, a quasi-capacitively coupled plasma is formed in the operating state by at least two plasma anchors. Thus, the plasma region with the highest energy density is spatially decoupled from the plasma anchors.

A quasi-capacitively coupled high-frequency plasma is a plasma region separated from the plasma anchors by a gas region with low plasma density. In a quasi-capacitively coupled plasma, small inductive and resistive portions also occur in the coupling region, while the plasma is mainly coupled capacitively. In practice, this means that energy coupling into the plasma does not occur exclusively through the displacement of charge carriers in the electric field (as in an ideal capacitor), but that collision processes and other interactions between the particles in the plasma also contribute to energy transfer. This coupling region lies in the range of 2-80 degrees of the electrical length of the high-frequency signal.

The high-frequency plasma light source according to example aspects of the invention comprises a pressure chamber containing a gaseous medium, in which the light-emitting plasma is present during operation. According to example aspects of the invention, an impedance transformation assembly is connected to the pressure chamber. This assembly has a coupling pin for coupling electromagnetic waves into the high-frequency plasma light source. Furthermore, the assembly has a coaxial conductor with an inner conductor and an outer conductor, with a dielectric pressure seal and at least one electrically conductive or dielectric connection being present between the inner conductor and the outer conductor. The electrically conductive or dielectric connection serves to match the impedance.

The term “operating state” refers to the state of the high-frequency plasma light source in which a stable, light-emitting plasma is generated within the pressure chamber.

According to example aspects of the invention, the high-frequency plasma light source further comprises an inner conductor plasma anchor and an outer conductor plasma anchor. The inner conductor plasma anchor extends into the pressure chamber, such that a first end is positioned within the pressure chamber. The other end is electrically and mechanically connected to the inner conductor of the coaxial conductor. The inner conductor plasma anchor thus serves, at least in a subsection, as the inner conductor of the coaxial conductor. In the outer conductor plasma anchor, a first end is positioned within the pressure chamber. The other end of the outer conductor plasma anchor is mechanically connected to the inner surface of the pressure chamber. Optionally, this connection can also be electrical.

Plasma in the high-frequency plasma light source according to example aspects of the invention is essentially the spatial region of an ionized gas medium that is generated within the pressure chamber by the action of high-frequency electromagnetic energy. Using the energy coupled into the pressure chamber, electrons are separated from atoms or molecules of the gas in a specific spatial region of the pressure chamber, thus forming a mixture of electrons, ions, neutral atoms, or molecules. In contrast to DC and low-frequency AC plasmas, the electrically conductive particles in a high-frequency plasma are quasi-stationary because the free paths are very short. Through the energy input and collision processes between the particles, components of this mixture are raised to higher energy levels. When the particles fall back to lower energy levels (recombination), photons are emitted according to the energy difference between the energy levels.

The plasma is ignited in the pressure chamber in an area of locally elevated electric field strength. The plasma is then heated and sustained via the coupling of the electromagnetic energy that is as reflection-free as possible. In the high-frequency plasma light source according to example aspects of the invention, the plasma is ignited and sustained between the two plasma anchors, with the plasma located between the two plasma anchors and the regions of the plasma with the highest energy density spatially decoupled from the plasma anchors.

The high-frequency plasma light source according to example aspects of the invention therefore has a significantly longer service life, since the plasma anchors are affected by electrode burn-up to a significantly lesser extent, in contrast to the electrodes of known discharge lamps which are operated by direct current or low-frequency alternating voltage and are referred to below as direct current discharge lamps.

A plasma anchor within the context of example aspects of the invention is a type of electrode, whereby the function of an electrode within the context of example aspects of the invention differs from an electrode in a direct current discharge lamp, in which an arc is formed between electrodes. The arc in a direct current discharge lamp is essentially created by a current flow between an anode and a cathode. Thus, in known direct current discharge lamps, a high current flows from the interior of the electrodes through the surface of the electrodes. In example aspects of the present invention, as described above, the energy input is achieved by high-frequency electromagnetic fields. In the operating state of the high-frequency plasma light source according to example aspects of the invention, therefore, unlike in direct current discharge lamps, no current flows from the interior of the plasma anchors through the surface of the plasma anchors. This ensures that, according to example aspects of the invention, no work function of charge carriers from the plasma anchors needs to be overcome during the operating state. The heating of the plasma anchors due to the energy release of the work function is thereby prevented.

One advantage of the high-frequency plasma light source according to example aspects of the invention is that significantly higher power densities can be achieved, since the plasma anchors in example aspects of the invention are not heated by the work function of the charge carriers, as is the case with the electrodes in conventional DC discharge lamps. Thus, in example aspects of the invention, hardly any energy is used on the work function of electrons, meaning that almost all of the coupled power is available for heating the plasma. Thus, example aspects of the invention enable extremely efficient operation of a high-frequency plasma light source.

The high-frequency plasma light source according to example aspects of the invention also makes it possible to improve the temporal stability of the plasma. In contrast to known direct current discharge lamps, the temporally varying work function of the charge carriers at the electrodes, which leads to instabilities and movements of the plasma, does not affect the invention in example embodiments.

To improve the stability of the plasma between the inner conductor plasma anchor and the outer conductor plasma anchor, as well as to increase the decoupling of the plasma from the plasma anchors, the opposing surfaces of the plasma anchors can have predetermined shapes. In a first example variant, the first end of the inner conductor plasma anchor, i.e., the end located within the pressure chamber, can have a flat surface. In this variant, the first end of the outer conductor plasma anchor is designed as a convex, e.g., pointed end, and lies opposite the first end of the inner conductor plasma anchor. Of course, in an expedient embodiment of this first variant, it is also possible for the first end of the inner conductor plasma anchor to have a convex shape.

In a second example variant, the first end of the inner conductor plasma anchor is designed as a concave surface. The first end of the outer conductor plasma anchor is also designed as a concave surface and is arranged opposite the first end of the inner conductor plasma anchor. Any combination of concave and convex plasma anchors is also possible. Ideally, a plasma with a radially symmetric shape is formed, with a low power density on the surface and a power density in the core that continuously increases or remains constant with decreasing diameter.

The gaseous medium used in the high-frequency plasma light source according to example aspects of the invention can be, for example, noble gases, mercury, deuterium, or gas mixtures thereof. To adjust the emitted spectrum, additives such as metal halides can optionally be added to the gaseous medium. The operating pressure within the pressure chamber can vary between 1 mbar and 250 bar, depending on the application. The frequency range of the electromagnetic energy used to feed the plasma can be between 0.01 GHz and 100 GHz. In one example embodiment of the invention, the high-frequency plasma light source has a channel for filling the gaseous medium into the pressure chamber.

The inner conductor plasma anchor and the outer conductor plasma anchor can be made of tungsten or a tungsten alloy, thus exhibiting a high melting temperature. For example, a plasma anchor can be made of pure tungsten or tungsten with oxide additives such as zirconium oxide, thorium dioxide, lanthanum oxide, or mixed oxides of rare earth elements.

In the high-frequency plasma light source according to example aspects of the invention, the impedance transformation assembly, hereinafter also referred to as an impedance transformer, comprises a coupling pin for coupling high-frequency electromagnetic waves into the high-frequency plasma light source, a coaxial conductor with an inner conductor and an outer conductor, and inductive and/or capacitive elements. The impedance transformer serves on the one hand as a hermetic seal for the pressure chamber. On the other hand, the impedance transformer enables low-reflection coupling of the high-frequency electromagnetic waves into the pressure chamber. In the operating state, this enables a virtually loss-free coupling of the power of the high-frequency electromagnetic wave into the plasma, thereby heating and sustaining the plasma.

In one example embodiment of the invention, the coupling pin is mechanically and electrically connected to the inner conductor of the coaxial conductor. This ensures that the electromagnetic wave coupled into the high-frequency plasma light source via the coupling pin can be transmitted into the impedance transformer with virtually loss-free.

In one example variant of the invention, the coupling pin, the inner conductor of the coaxial conductor, and the inner and outer conductor plasma anchors are arranged on a common axis. This enables a compact design, optimal transmission of electromagnetic energy, and optimal optical light output.

To seal the high-frequency plasma light source from the surrounding, the dielectric pressure seal radially encloses the coupling pin. This hermetically seals the areas between the inner and outer conductors of the coaxial conductor, as well as the adjacent pressure chamber, from the surrounding.

A further example embodiment of the invention provides that the least one electrical or dielectric connection between the inner conductor and the outer conductor of the coaxial conductor is formed by a single component. This single component, hereinafter referred to as an impedance element, has a coaxial inner conductor section and at least one connecting bar that electrically or dielectrically connects the coaxial inner conductor section to the outer conductor of the coaxial conductor of the coaxial conductor. The coaxial inner conductor section is to be understood as a section of the inner conductor of the coaxial conductor of the impedance transformer.

The impedance element essentially establishes an electrical or dielectric connection between the inner and outer conductors of the coaxial conductor and serves to match the impedance. This ensures virtually loss-free coupling of the electromagnetic power into the plasma. The least one connecting bar forms a radial connection between the coaxial inner conductor section of the inductive or capacitive impedance element and the outer conductor of the coaxial conductor. If multiple connecting bars are present, these multiple connecting bars can be arranged at one point and/or along a longitudinal direction of the coaxial inner conductor section radially around this coaxial inner conductor section.

Advantageously, the inner conductor plasma anchor and the coupling pin are arranged on opposite sides of the impedance transformer and thus on opposite sides of the impedance element. This enables a modular design of the high-frequency plasma light source, allowing individual components to be quickly replaced or serviced. In the operating state, high temperatures occur at the plasma anchors while sustaining the hot plasma. Effective heat dissipation from the inner conductor plasma anchors ensures a long service life of the plasma anchors and a constant light output. Furthermore, degradation of the light quality over time is reduced. Furthermore, optimal heat dissipation allows for increased power input and thus increased plasma power densities and, consequently, an increase in total irradiance. Furthermore, optimal cooling can increase the economic efficiency of the light source by reducing maintenance costs and downtime.

Example embodiments of the invention are described below, which contribute to the dissipation of heat from the plasma anchors. One example embodiment provides that the least one connecting bar of the impedance element and the coaxial inner conductor section have cooling channels which are connected to cooling channels in the impedance transformer. In an impedance element with at least two connecting bars, the cooling channel of the coaxial inner conductor section serves, at least in a subsection, as a connecting channel between the cooling channels of the at least two connecting bars. The cooling channel of the coaxial inner conductor section can form a cooling conductor section along the longitudinal direction of the coaxial inner conductor section. Heat can thus be dissipated from the inner conductor plasma anchor via the impedance element to the impedance transformer. Water, insulating oil, or nitrogen can expediently be used for cooling.

In a further example embodiment a cooling channel is present in the inner conductor plasma anchor, expediently along its longitudinal direction, which is directly connected to at least one cooling channel of the impedance element.

Another example embodiment provides that the inner conductor plasma anchor has a cooling channel, preferably along its longitudinal direction, which is connected to at least one cooling channel of the impedance transformer. Thus, the heat from the inner conductor plasma anchor is dissipated directly toward the impedance transformer. The least one cooling channel can be designed as a connecting bar and represent both a mechanical connection and an additional electrical connection.

In a further example development of the cooling system, it is possible for the inner conductor plasma anchor and the coaxial inner conductor section to be designed as a heat pipe. In this case, the inner conductor plasma anchor and the coaxial inner conductor section have a connected, closed cavity which extends from the first end of the inner conductor plasma anchor along the opposite other end of the inner conductor plasma anchor into the coaxial inner conductor section. In the operating state, the first end of the inner conductor plasma anchor faces the thermally hot plasma and the other end faces the impedance element. The heat generated at the first end of the inner conductor plasma anchor is conducted via the heat pipe to the impedance element and dissipated via a cooling channel in the at least one connecting bar to the impedance transformer. It is expedient for the heat pipe to be formed only in the inner conductor plasma anchor.

A further example embodiment of the invention provides that the pressure chamber has a reflector and a pressure-tight window opposite the reflector for light exit. The reflector serves to reflect the light emitted by the plasma out of the pressure chamber.

The optical axis of the reflector expediently coincides with the axis of the inner conductor plasma anchor and the focal point of the reflector lies in the region of the highest energy density of the plasma during operation of the high-frequency plasma light source.

In one example variant of the invention, the reflector can be an elliptical reflector, a parabolic reflector, or a freeform reflector. The reflector can form the inner surface of the pressure chamber. However, it is also possible for the reflector to be a separate component inside or outside a pressure chamber designed as a glass body. The pressure-tight window for the light exit can also be a convex lens, a concave lens, or an aspherical freeform lens. In the case of a glass body as a pressure chamber, the lens can also be integrated into the glass body. The window can be made of quartz or sapphire.

In one example variant of the invention, one or more mechanical struts for the outer conductor plasma anchor are provided, which are attached to the inner surface of the pressure chamber. The one or more mechanical struts are advantageously designed such that they only slightly obstruct the light emitted by the plasma.

In a further example variant of the high-frequency plasma light source according to the invention, the one or more mechanical struts are designed such that, in the operating state, the heat generated in the outer conductor plasma anchor can be optimally dissipated. For this purpose, the one or more mechanical mounts and the outer conductor plasma anchor have at least one cooling channel, which may be connected to the cooling channel of the inner conductor plasma anchor.

### BRIEF DESCRIPTION OF THE DRAWINGS

Example aspects of the invention and further example advantages of the invention are explained using the following drawings.

FIG. 1 shows a schematic high-frequency plasma light source according to example aspects of the invention in a sectional view;

FIG. 2 shows several schematic example embodiments of the inner conductor plasma anchor and the outer conductor plasma anchor;

FIG. 3 shows several schematic example embodiments of an impedance element;

FIG. 4 is a schematic example representation of a cooling system for an inner conductor plasma anchor with heat pipe.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

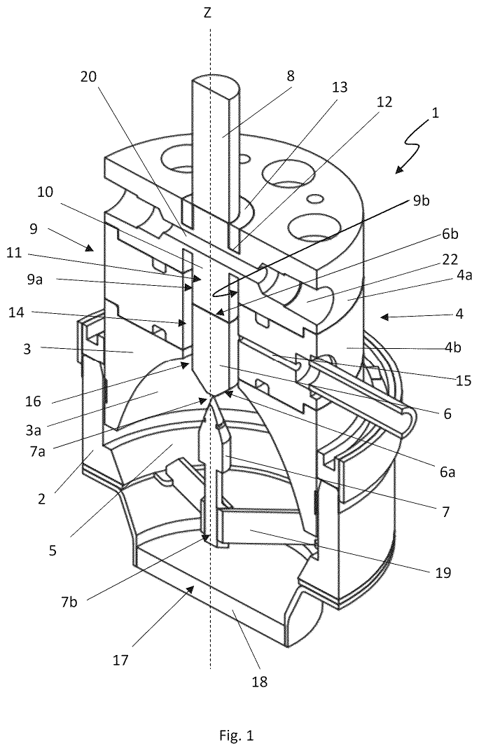

FIG. 1 shows a schematic sectional view of a high-frequency plasma light source 1 according to example aspects of the invention. The high-frequency plasma light source 1 comprises a lamp body 2, a reflector 3, and an impedance transformer 4. Furthermore, the high-frequency plasma light source 1 comprises a pressure chamber 5 in which an inner conductor plasma anchor 6 and an outer conductor plasma anchor 7 are arranged. The light-emitting plasma (not shown) is ignited between the two plasma anchors 6, 7 and heated when the high-frequency plasma light source 1 is in operation.

The impedance transformer 4 has a coupling pin 8, a coaxial conductor 9 with an inner conductor 9a and an outer conductor 9b, and an impedance element 10. In FIG. 1, the impedance transformer 4 is exemplarily shown in two parts with an upper part 4a and a lower part 4b, with the impedance element 10 being positioned in the upper part 4a and the inner conductor plasma anchor 6 being positioned at least partially in the lower part 4b. However, it is possible for the impedance transformer 4 to be designed in one piece. The coupling pin 8 is arranged on a common axis Z with the inner conductor 9a of the coaxial conductor 9, the inner conductor plasma anchor 6, and the outer conductor plasma anchor 7. The coupling pin 8 is mechanically and electrically connected to the inner conductor 9a of the coaxial conductor 9. The coupling pin 8 thus represents a subsection of the inner conductor 9a. The coupling pin 8 and the inner conductor 9a of the coaxial conductor 9 can be formed as a single piece. Electromagnetic energy from a high-frequency source (not shown) is transmitted via the coupling pin 8 through the coaxial conductor 9 and the inner conductor plasma anchor 6 into the pressure chamber 5.

A channel 15 is formed in the impedance transformer 4, through which a gaseous medium (not shown) can be introduced into the high-frequency plasma light source 1. In FIG. 1, this channel 15 is exemplarily formed in the region of the coaxial conductor 9, so that the gaseous medium can be filled into the intermediate space 14 between the inner conductor 9a and the outer conductor 9b of the coaxial conductor 9 and the adjacent pressure chamber 5. However, it is also possible for the channel 15 to be formed in the region of the reflector 3 or the lamp body 2 (not shown). Exemplarily in FIG. 1, the intermediate space 14 between the inner conductor 9a and the outer conductor 9b of the coaxial conductor 9 and the pressure chamber 5 are directly connected to one another via an opening 16 in the reflector 3. However, it is possible for the pressure chamber 5 to be sealed off from the intermediate space 14 by means of a further dielectric pressure seal (not shown).

The impedance element 10 consists of a coaxial inner conductor section 11 and for example two connecting bars 12, which represent a mechanical and electrical connection between the coaxial inner conductor section 11 and the outer conductor 9b of the coaxial conductor 9. The coaxial inner conductor section 11 thus represents a further subsection of the inner conductor 9a of the coaxial conductor 9. The two connecting bars 12 each have a cooling channel 20, which is connected to a cooling channel 22 in the impedance transformer 4. Heat can be dissipated from the inner conductor plasma anchor 6 by means of these cooling channels 20, 22.

The inner conductor plasma anchor 6 is arranged with the impedance element 10 on the opposite side of the coupling pin 8. The inner conductor plasma anchor 6 extends through the opening 16 of the reflector 3 into the pressure chamber 5, so that the first end 6a of the inner conductor plasma anchor 6 is positioned within the pressure chamber 5. The other end 6b of the inner conductor plasma anchor 6 is electrically and mechanically connected to the impedance element 10. In FIG. 1, the inner conductor plasma anchor 6 extends, for example, into the coaxial conductor 9, so that the other end 6b is positioned within the coaxial conductor 9. The inner conductor plasma anchor 6 thus forms a further subsection of the inner conductor 9a of the coaxial conductor 9. An annular dielectric pressure seal 13 radially surrounds the coupling pin 8 and seals the intermediate space 14 between the inner conductor 9a and the outer conductor 9b of the coaxial conductor 9. This seals the high-frequency plasma light source 1 from the external surrounding.

The reflector 3 and the lamp body 2 together form the pressure chamber 5. The reflector 3 is connected to the impedance transformer 4 and, as described above, has an opening 16 through which the inner conductor plasma anchor 6 extends into the pressure chamber 5. On the opposite side of the opening 16, the lamp body 2 has a further opening 17 with a window 18 through which the light emitted by the plasma can exit the pressure chamber 5. The reflector 3 and the lamp body 2 and/or the reflector 3 and the impedance transformer 4 can also be formed as a single piece.

The outer conductor plasma anchor 7 is arranged within the pressure chamber 5. The first end 7a of the outer conductor plasma anchor 7 is opposite to the first end 6a of the inner conductor plasma anchor 6. In the operating state, the plasma is formed between these two first ends 6a, 7a of the plasma anchors 6, 7. The outer conductor plasma anchor 7 is held by several, exemplarily shown in FIG. 1 by two, struts 19. These struts 19 are connected to the lamp body 2.

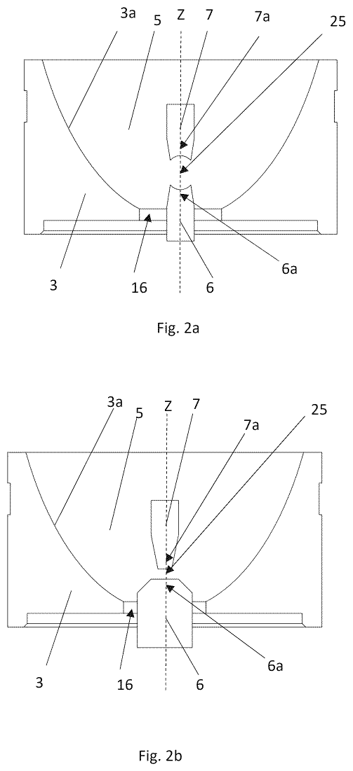

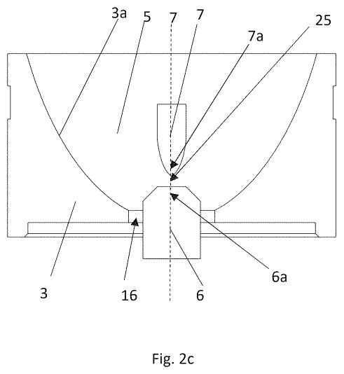

FIG. 2a schematically shows a section of a pressure chamber 5 with a first example embodiment of an inner conductor plasma anchor 6 and an outer conductor plasma anchor 7. As described above, the inner conductor plasma anchor 6 extends through an opening 16 in the reflector 3 into the pressure chamber 5, so that the first end 6a of the inner conductor plasma anchor 6 and the first end 7a of the outer conductor plasma anchor 7 are opposite to each other. For reasons of clarity, only the first end 7a of the outer conductor plasma anchor 7 is shown.

The two plasma anchors 6, 7 lie on a common axis Z. The focal point 25 of the reflector 3 also lies on this common axis Z. The position of the focal point 25 is essentially determined by the shape of the surface 3a of the reflector 3. The focal point 25 is located between the two first ends 6a, 7a of the plasma anchors 6, 7.

The opposite surfaces of the first ends 6a, 7a of the plasma anchors 6, 7 are concave in FIG. 2a.

FIG. 2b schematically shows a section of a pressure chamber 5 with a second example embodiment of an inner conductor plasma anchor 6 and an outer conductor plasma anchor 7. The arrangement of the plasma anchors 6, 7 corresponds to the arrangement in FIG. 2a. To avoid repetition, reference is made to that embodiment. The two first ends 6a, 7a are each flat or planar. For example, the cross-section of the first end 7a of the outer conductor plasma anchor 7 is smaller than the cross-section of the first end of the inner conductor plasma anchor 6.

FIG. 2c schematically shows a section of a pressure chamber 5 with a third example embodiment of an inner conductor plasma anchor 6 and an outer conductor plasma anchor 7. The arrangement of the plasma anchors 6, 7 corresponds to the arrangement in FIG. 2a and FIG. 2b, respectively. To avoid repetition, reference is made to the embodiment therein. In contrast to FIG. 2a and FIG. 2b, the opposite ends 6a, 7a of the plasma anchors 6, 7 have different shapes. In FIG. 2c, the first end 6a of the inner conductor plasma anchor 6 is flat or planar. In contrast, the first end 7a of the outer conductor plasma anchor 7 is designed with a tip.

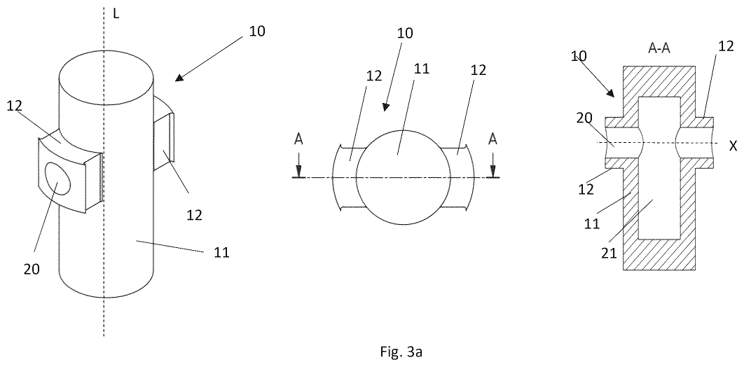

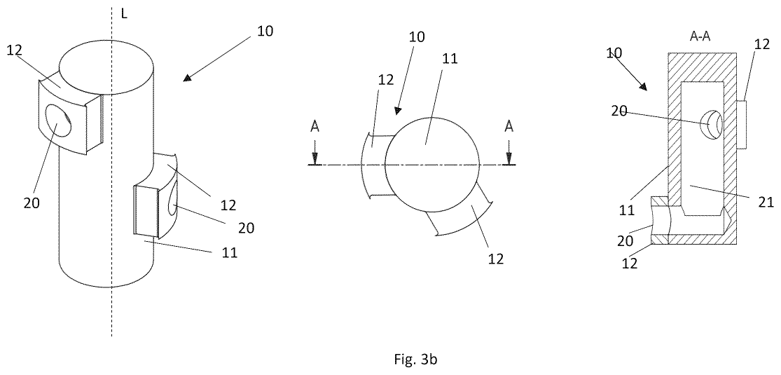

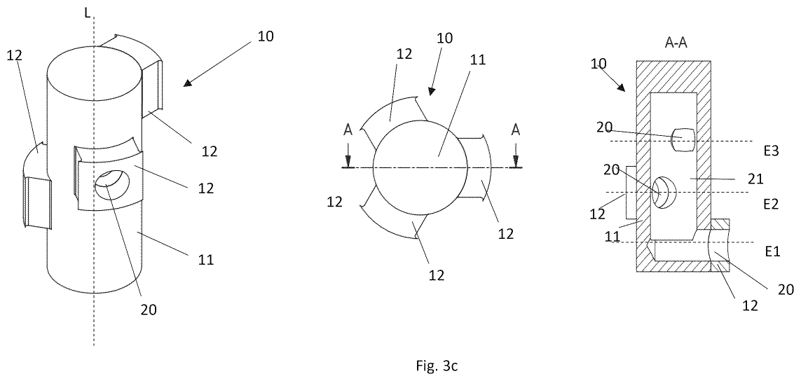

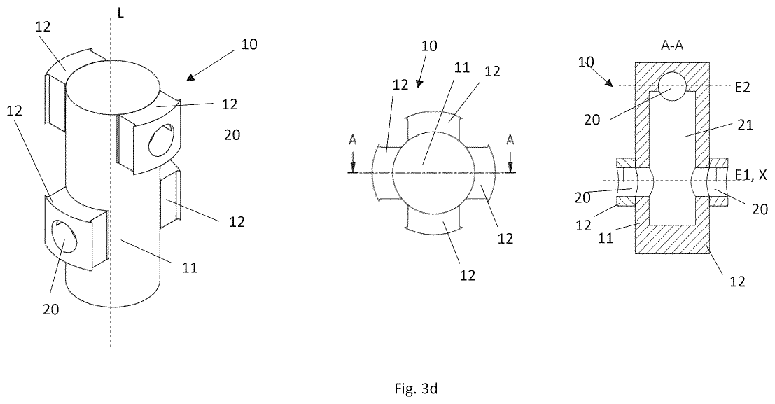

FIGS. 3a to 3d show various embodiments of an impedance element 10. Each figure has three representations, the left representation showing a perspective view, the middle one a plan view and the right one a sectional view of the example impedance element 10 along a section axis A-A.

FIG. 3a shows an impedance element 10 with two connecting bars 12 and a coaxial inner conductor section 11. The connecting bars 12 are arranged radially on the coaxial inner conductor section 11 and are exemplarily at an angle of 180° to one another. Furthermore, the connecting bars 12 lie on a common axis X, which runs perpendicular to the longitudinal orientation L of the coaxial inner conductor section 11. The two connecting bars 12 each have a cooling channel 20, with one cooling channel 20 serving as an inlet for a cooling medium (not shown) and the other cooling channel 20 serving as an outlet for the cooling medium. The coaxial inner conductor section 11 of the impedance element 10 also has a cooling channel 21, which is connected to the two cooling channels 20 of the connecting bars 12. Since the cooling channels 20 of the connecting bars 12 lie on the common axis X, the path of the coolant through the cooling channel 21 of the coaxial inner conductor section 11 is short.

FIG. 3b shows an impedance element 10 with two connecting bars 12 and a coaxial inner conductor section 11. The connecting bars 12 are also arranged radially on the coaxial inner conductor section 11, however the angle between the connecting bars is between 0° and 180°. The connecting bars 12 are also offset from one another along the longitudinal direction L of the coaxial inner conductor section 11. As in FIG. 3a, the connecting bars 12 and the coaxial inner conductor section 11 have cooling channels 20, 21 which are interconnected, with one cooling channel 20 serving as an inlet for a cooling medium (not shown) and the other cooling channel 20 serving as an outlet for the cooling medium. Due to the arrangement of the cooling channels 20 of the connecting bars 12, the coolant is directed through the cooling channel 21 of the coaxial inner conductor section 11. This further improves heat dissipation.

FIG. 3c shows an impedance element 10 with three connecting bars 12 and a coaxial inner conductor section 11. As described in FIG. 3a and FIG. 3b, the connecting bars 12 with their cooling channels 20 are arranged radially on the coaxial inner conductor section 11 and along the longitudinal direction L of the coaxial inner conductor section 11. The connecting bars 12 are exemplarily at an angle of 120° to one another. In FIG. 3c, the cooling channels 20 are arranged exemplarily in three planes E1, E2, E3 that run perpendicular to the longitudinal axis L of the coaxial inner conductor section 11 and are spaced with respect to each other. Either one or two cooling channels 20 can serve as an inlet or outlet, thereby further improving the effectiveness of heat dissipation.

FIG. 3d shows an impedance element 10 with four connecting bars 12 and a coaxial inner conductor section 11 with their respective cooling channels 20, 21. The connecting bars 12 are arranged, as shown in FIGS. 3a-3c, radially on the coaxial inner conductor section 11 and along the longitudinal direction L of the coaxial inner conductor section 11. Expediently, two cooling channels 20 are formed as inlets and two cooling channels 20 as outlets for a coolant. In FIG. 3d, the cooling channels 20 are exemplarily arranged in two planes E1, E2 that run perpendicular to the longitudinal axis L of the coaxial inner conductor section 11 and are spaced with respect to each other. The cooling channels 20 of one plane E1, E2 are located opposite each other, i.e., they lie on a common axis X. The cooling channels 20 of one plane E1, E2 serve as the inlet and the cooling channels 20 of the other plane E2, E1 serve as the outlet for a coolant. This enables effective coolant transport through the cooling channel 21 of the coaxial inner conductor section 11.

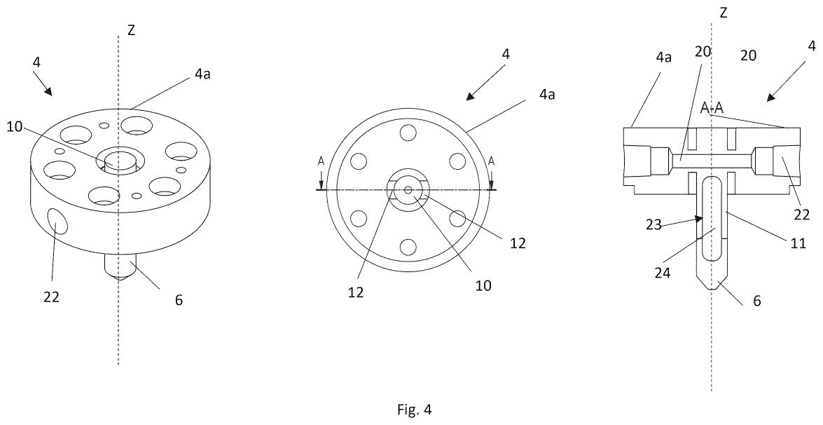

FIG. 4 shows an example embodiment of a cooling system for an inner conductor plasma anchor 6 with heat pipe 23. Three representations are shown, with the left representation showing a perspective view, the middle one a plan view and the right one a sectional view along a section axis A-A.

Shown is the upper part 4a of a mirror-symmetrical impedance transformer 4 with an impedance element 10 positioned on the rotation axis Z of the impedance transformer 4. The inner conductor plasma anchor 6 is located on the rotation axis Z, directly adjacent to the coaxial inner conductor section 11. The inner conductor plasma anchor 6 of the coaxial inner conductor section 11 of the impedance element 10 is designed as a heat pipe 23. The heat pipe 23 is formed from a cavity 24 that extends within the inner conductor plasma anchor 6 to within the coaxial inner conductor section 11. The cavity 24 is sealed off from the surrounding.

The impedance element 10 has two connecting bars 12 with two connected cooling channels 20, which connect the impedance element 10 to the cooling channels 22 in the upper part 4a of the impedance transformer 4. Thus, heat is dissipated from the inner conductor plasma anchor 6 via the heat pipe 23, the cooling channels 20 of the connecting bars 12 of the impedance element 10, and the cooling channels 22 in the upper part 4a of the impedance transformer 4.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### LIST OF REFERENCE NUMBERS

1 High-frequency plasma light source
2 Lamp body
3 Reflector
3a Reflector surface
4 Impedance transformer
4a Upper part of the impedance transformer
4b Lower part of the impedance transformer
5 Pressure chamber
6 Inner conductor plasma anchor
6a First end of the inner conductor plasma anchor
6b Other end of the inner conductor plasma anchor
7 Outer conductor plasma anchor
7a First end of the outer conductor plasma anchor
7b Other end of the outer conductor plasma anchor
8 Coupling pin
9 Coaxial conductor
9a Inner conductor of the coaxial conductor
9b Outer conductor of the coaxial conductor
10 Impedance element
11 Coaxial inner conductor section
12 Connecting bar
13 Pressure seal
14 Intermediate space
15 Cooling medium inlet
16 Opening
17 Additional opening
18 Window
19 Strut
20 Cooling channel in the connecting bar
21 Cooling channel in the coaxial inner conductor section
22 Cooling channel in the impedance transformer
23 Heat pipe
24 Cavity
25 Focal point
L Longitudinal axis
X Common axis of the connecting bars
E1 Plane of the connecting bars
E2 Plane of the connecting bars
Z Common axis/axis of rotation

1-17. (canceled)

18. A high-frequency plasma light source (1), in which a quasi-capacitively coupled plasma is formed by at least two plasma anchors (6, 7) in an operating state of the high-frequency plasma light source (1) such that a region of the quasi-capacitively coupled plasma with the greatest energy density in the operating state is spatially decoupled from the plasma anchors (6, 7), the high-frequency plasma light source (1) comprising:
a pressure chamber (5) containing a gaseous medium, the quasi-capacitively coupled plasma formed in gaseous medium the operating state;
an impedance transformer (4) assembly connected to the pressure chamber (5), the impedance transformer (4) assembly comprising a coupling pin (8) configured for coupling of electromagnetic waves into the high-frequency plasma light source (1), the impedance transformer (4) assembly further comprising a coaxial conductor (9) with an inner conductor (9a) and an outer conductor (9b), wherein a dielectric pressure seal (13) and at least one electrically conductive or dielectric connection (10, 12) are disposed between the inner conductor (9a) and the outer conductor (9b);
an inner conductor plasma anchor (6) extending into the pressure chamber (5), the inner conductor plasma anchor (6) electrically and mechanically connected to the inner conductor (9a) of the coaxial conductor (9); and
an outer conductor plasma anchor (7) with a first end (7a) positioned within the pressure chamber (5) and a second end (7b) mechanically connected to an inner surface of the pressure chamber (5).

19. The high-frequency plasma light source (1) of claim 18, wherein the coupling pin (8) is electrically and mechanically connected to the inner conductor (9a) of the coaxial conductor (9).

20. The high-frequency plasma light source (1) of claim 18, wherein the coupling pin (8), the inner conductor (9a) of the coaxial conductor (9), and the inner and outer conductor plasma anchors (6, 7) are aligned on a common axis (Z).

21. The high-frequency plasma light source (1) of claim 18, wherein the coupling pin (8) is radially enclosed by the dielectric pressure seal (13) to seal the high-frequency plasma light source (1) from the surrounding.

22. The high-frequency plasma light source (1) of claim 18, wherein the inner conductor plasma anchor (6) and the coupling pin (8) are arranged on opposite sides of an impedance element (10).

23. The high-frequency plasma light source (1) of claim 18, wherein at least one electrical or dielectric connection (10, 12) is arranged between the inner conductor (9a) and the outer conductor (9b) of the coaxial conductor (9) by an impedance element (10) having a coaxial inner conductor section (11) and at least one connecting bar (12) the mechanically and electromagnetically connects the coaxial inner conductor section (11) with the outer conductor (9b) of the coaxial conductor (9).

24. The high-frequency plasma light source (1) of claim 23, wherein a plurality of interconnected cooling channels (20,21) are disposed between the at least one connecting bar (12) and the coaxial inner conductor section (11), which are connected to at least one cooling channel (22) of the impedance transformer (4).

25. The high-frequency plasma light source (1) of claim 23, wherein the inner conductor plasma anchor (6) and the coaxial inner conductor section (11) of the impedance element (10) comprise a heat pipe (23).

26. The high-frequency plasma light source (1) of claim 18, wherein a cooling channel is disposed in the inner conductor plasma anchor (6), and the cooling channel in the inner conductor plasma anchor (6) is directly connected to at least one cooling channel (22) of the impedance transformer (4).

27. The high-frequency plasma light source (1) of claim 26, wherein the inner conductor plasma anchor (6) and a coaxial inner conductor section (11) of the impedance element (10) comprise a heat pipe (23).

28. The high-frequency plasma light source (1) of claim 18, wherein the pressure chamber (5) comprises a reflector (3) and a pressure-tight window (18) opposite the reflector (3) configured for light exit.

29. The high-frequency plasma light source (1) of claim 28, wherein an optical axis of the reflector (3) coincides with an axis (Z) of the inner conductor plasma anchor (6), and a focal point (25) of the reflector (3) is disposed at the region of the quasi-capacitively coupled plasma with the greatest energy density in the operating state.

30. The high-frequency plasma light source (1) of claim 28, wherein the reflector (3) comprises one or more of an elliptical reflector, a parabolic reflector, and a free-form reflector, and the pressure-tight window (18) comprises one or more of a convex lens, a concave lens, and an aspherical free-form lens.

31. The high-frequency plasma light source (1) of claim 18, further comprising one or more mechanical struts (19) for the outer conductor plasma anchor (7), the one or more mechanical struts (19) attached to the inner surface of the pressure chamber (5).

32. The high-frequency plasma light source (1) of claim 31, further comprising at least one cooling channel for the mechanical struts (19) and the outer conductor plasma anchor (7).

33. The high-frequency plasma light source (1) of claim 32, wherein the at least one cooling channel for the mechanical struts (19) and the outer conductor plasma anchor (7) are connected to a cooling channel of the inner conductor plasma anchor (6).

34. The high-frequency plasma light source (1) of claim 18, further comprising a flat or convex surface at a first end (6a) of the inner conductor plasma anchor (6) that is positioned opposite a pointed first end (7a) of the outer conductor plasma anchor (7).

35. The high-frequency plasma light source (1) of claim 18, further comprising a concave surface at a first end (6a) of the inner conductor plasma anchor (6) that is positioned opposite a concave surface at a first end (7a) of the outer conductor plasma anchor (7).

36. The high-frequency plasma light source (1) of claim 18, further comprising a channel (15) configured for directing a flow of gaseous medium into the pressure chamber (5).
